(19) United States
(12) Patent Application Publication
(10) Pub. No.: US 2020/0285520 A1
(43) Pub. Date: Sep. 10, 2020

(54) INFORMATION PROCESSOR, INFORMATION PROCESSING SYSTEM, AND METHOD OF PROCESSING INFORMATION

(71) Applicant: HITACHI, LTD., Tokyo (JP)

(72) Inventors: Kazushi Nakagawa, Tokyo (JP); Yoshifumi Fujikawa, Tokyo (JP); Satoru Watanabe, Tokyo (JP); Toshiyuki Aritsuka, Tokyo (JP)

(73) Assignee: HITACHI, LTD., Tokyo (JP)

(21) Appl. No.: 16/552,146

(22) Filed: Aug. 27, 2019

(30) Foreign Application Priority Data
Mar. 6, 2019 (JP) 2019-041066

(51) Int. Cl. G06F 9/50; G06F 9/48; G06F 9/38; G06F 16/2453; G06F 16/28

(52) U.S. Cl. CPC G06F 9/5027; G06F 9/48; G06F 16/285; G06F 16/24542; G06F 9/3861

(57) ABSTRACT

Processing performance is improved through introduction of accelerators and availability of the system is enhanced during introduction of the accelerators. A worker node includes a processor such as CPU, an accelerator that executes accelerator processing on a command, and a software model that operates on the CPU and executes software model processing of the command. In the worker node, the CPU breaks down an accelerator operator included in a query plan into a plurality of accelerator commands, sends each of the accelerator commands to the accelerator or the software model, and switches the destination of the accelerator command from the accelerator to the software model when a switching condition for changing the processing component of the accelerator command is satisfied.

### CLAIM OF PRIORITY

The present application claims priority to Japanese Patent Application No. 2019-041066 filed on Mar. 6, 2019, the content of which is hereby incorporated by reference into this application.

### BACKGROUND OF THE INVENTION

### 1. Field of the Invention

The present invention relates to an information processor, an information processing system, and a method of processing information, and is suitably applied to an information processor, an information processing system, and a method of processing information for a data system for analyzing big data, for example.

### 2. Description of the Related Art

In recent years, standard query language (SQL) on Hadoop for distributed databases has become popular in the field of big data analysis. Examples of typical SQL on Hadoop include Apache Drill and Apache Impala.

SQL on Hadoop includes multiple node servers. If several nodes become non-available due to failure, etc., during query processing, the query returns an error, and subsequent SQL query processing is executed by the other nodes operating normally. For example, JP-2015-176369-A discloses a technique of stopping the operation of a device among multiple devices to be controlled when an error is detected in the corresponding device, and operating the remaining devices in fallback mode.

A distributed database system requires many nodes to achieve a certain performance level for high-speed processing of large volumes of data. This results in an increase in the system scale, and unfortunately causes an increase in introduction and maintenance costs.

One proposed solution to this problem is a method of suppressing the system scale by installing accelerators on the nodes of the distributed database system to increase the performance level per node, thereby decreasing the number of nodes. An example of a typical accelerator is a field programmable gate array (FPGA). An FPGA operates as a rewritable dedicated circuit and can achieve efficient processing through parallel processing.

Although an FPGA, which is a dedicated circuit, is advantageous because it is suitable for high-speed execution of specific processing, it is disadvantageous because it lacks flexibility due to the limited resources, such as memory. This unfortunately limits the functions compared with a database implemented only by software in the past. Since new FPGA devices are added to the system, failure processing of the FPGA devices also has to be taken into consideration.

The present invention, which has been conceived in consideration of the above-described points, proposes an information processor, an information processing system, and a method of processing information that have improved processing performance through the introduction of accelerators and that can enhance availability of the system by improving flexibility during introduction of the accelerators and troubleshooting.

### SUMMARY OF THE INVENTION

To solve such an issue, the present invention provides an information processor that executes query processing in accordance with a distributed query plan, the information processor including: a processor; an accelerator that executes, with a dedicated circuit, accelerator processing for processing a command; and a software model that operates on the processor and executes software model processing, with software, to process the command, the processor breaking down an accelerator operator included in the query plan into a plurality of accelerator commands and sending each of the accelerator commands to the accelerator or the software model, the processor switching a destination of the accelerator commands from the accelerator to the software model when a switching condition for changing a processing component of the accelerator commands is satisfied.

To solve such an issue, the present invention provides an information processing system processing a query with a cluster grouping a plurality of worker nodes, the information processing system including an application server that transmits the query to a first worker node in the cluster; the first worker node that receives the query from the application server, and distributes a query plan generated on a basis of the query to a second worker node in the cluster; and the second worker node that executes query processing in accordance with the query plan distributed by the first worker node, in which, the second worker node includes a processor, an accelerator that executes, with a dedicated circuit, accelerator processing for processing a command, and a software model that operates on the processor and executes software model processing, with software, to process the command, the processor breaks down an accelerator operator included in the query plan into a plurality of accelerator commands and sending each of the accelerator commands to the accelerator or the software model, and the processor switches a destination of the accelerator commands from the accelerator to the software model when a switching condition for changing a processing component of the accelerator commands is satisfied.

To solve such an issue, the present invention provides an method of processing information for an information processor that executes query processing in accordance with a distributed query plan and that includes a processor, an accelerator that executes, with a dedicated circuit, accelerator processing for processing a command, and a software model that operates on the processor and executes software model processing, with software, to process the command. The method includes: by the processor, breaking down an accelerator operator included in the query plan into a plurality of accelerator commands and sending each of the accelerator commands to the accelerator or the software model; and by the processor, switching a destination of the accelerator commands from the accelerator to the software model when a switching condition for changing a processing component of the accelerator commands is satisfied.

According to the present invention, processing performance can be improved through the introduction of accelerators and availability of the system can be enhanced during introduction of the accelerators.

### BRIEF DESCRIPTION OF THE DRAWINGS

FIG. 1 is a block diagram illustrating the hardware configuration of an information processing system according to an embodiment of the present invention;

FIG. 2 is a block diagram illustrating the functional configuration of the information processor according to the embodiment;

FIG. 3 illustrates an example of a switching control table;

FIGS. 4A and 4B each illustrates software model processing of an accelerator query plan;

FIG. 5 is a sequence diagram illustrating detailed steps of query processing;

FIG. 6 is a flowchart illustrating a control process by accelerator middleware;

FIG. 7 is block diagram illustrating a configuration example of an accelerator;

FIG. 8 illustrates a configuration example of a database file having a column store format;

FIG. 9 illustrates specific examples of the occurrence condition of accelerator overflow; and

FIGS. 10A and 10B are diagrams for comparing the progress of SQL query processing according to the embodiment when an accelerator overflow error occurs with past accelerator processing.

### DESCRIPTION OF THE PREFERRED EMBODIMENT

An embodiment of the present invention will now be described in detail with reference to the drawings.

### (1) Overall Configuration

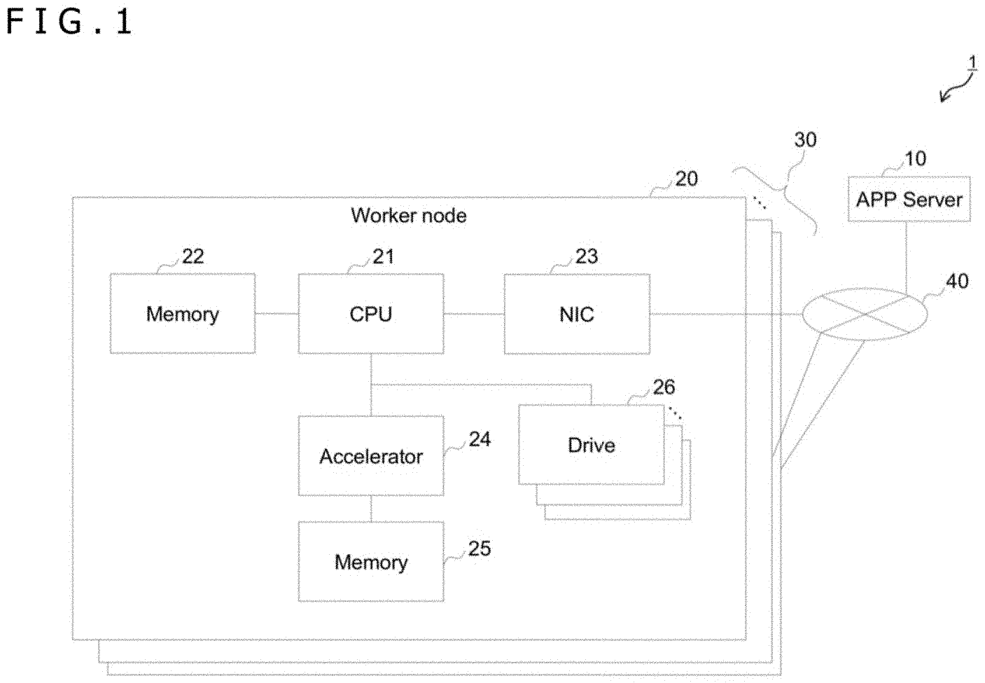

FIG. 1 is a block diagram illustrating the hardware configuration of an information processing system according to an embodiment of the present invention. In FIG. 1, a distributed database system 1 as whole is an example of an information processing system according to the embodiment.

As illustrated in FIG. 1, the distributed database system 1 includes an application server (APP server) 10, a cluster 30 grouping one or more worker nodes 20, and a network 40 communicably connecting these components.

The worker nodes 20 are connected to each other via the network 40, such as a local area network (LAN) or the Internet, and are further connected to the application server 10. Each of the worker nodes 20 includes a central processing unit (CPU) 21, a memory 22, a network interface card (NIC) 23, an accelerator 24, an external memory 25 of the accelerator, and at least one drive 26.

The CPU 21 loads the data stored in the drive 26 to the memory 22 to process the data, and communicates with other worker nodes 20 and the application server 10 via the NIC 23. The CPU 21 can offload a portion of the processing of programs operating on the CPU 21, or CPU processing, to the accelerator 24.

The accelerator 24 transfers a portion or all of the data loaded to the memory 22 to the external memory 25 of the accelerator, processes the data, and sends back the processed result to the memory 22, under the instruction of the CPU 21. The accelerator 24 is device that can efficiently process a portion of the CPU processing by a dedicated circuit. In specific, the accelerator 24 is, for example, a field programmable gate array (FPGA) or a graphic processing unit (GPU). The accelerator 24 and the CPU 21 are connected via a peripheral component interconnect express (PCIe), etc. The external memory 25 of the accelerator is, for example, a double-data-rate (DDR) memory, in specific.

The drive 26 is, for example, a hard disk drive (HDD) or a solid state drive (SSD), in specific.

In such a distributed database system 1, processing is executed in accordance with the flow described below.

First, a business intelligence (BI) tool or the like operating on the application server 10 queries a membership management node (not illustrated) to determine a first worker node 20 to which a query is to be sent among the worker nodes 20 in the cluster 30, and sends an SQL query to the first worker node 20. The first worker node 20 then analyzes the received SQL query, generates a query plan indicating the processing steps of the query, and distributes the query plan to the other worker nodes 20. The other worker nodes 20 then reads necessary data from the drive 26 in accordance with the distributed query plan, processes the data, and returns the processed result to the first worker node 20. The first worker node 20 then collectively processes the results from the all worker nodes 20 in the cluster 30, and returns a response corresponding to the result of the SQL query to the application server 10.

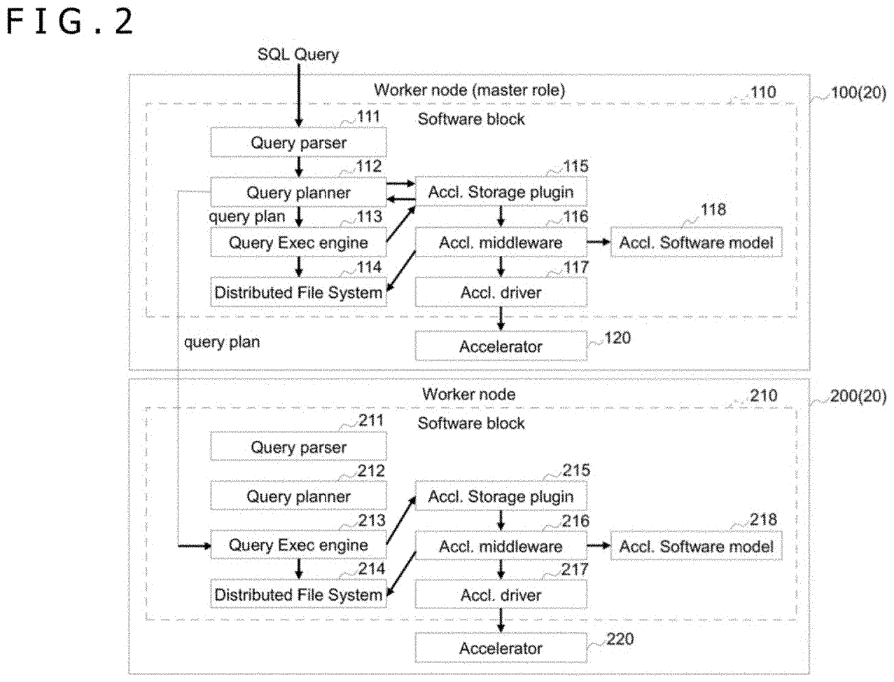

FIG. 2 is a block diagram illustrating the functional configuration of the information processor according to the embodiment. In FIG. 2, worker nodes 100 and 200 are examples of the information processor according to the embodiment and correspond to the worker nodes 20 of the distributed database system 1 illustrated in FIG. 1. The worker node 100 is a master role worker node, that is, “the first worker node 20” described above, to which the SQL query is sent. The worker node 200 is one of the worker nodes to which the query plan is distributed, i.e., one of “the other worker nodes 20” described above. Although the details are described below, the flow from the input of an SQL query to the execution of a query plan based on the SQL query is indicated by the arrows in FIG. 2.

As illustrated in FIG. 2, the functional configuration of the worker node 100 is categorized into a software functional block, or software block, 110 and an accelerator 120. The software functional block 110 is realized by processing executed by the CPU 21 illustrated in FIG. 1. The accelerator 120 is realized by processing executed by the accelerator 24 including a dedicated circuit, and can perform a portion of the CPU processing.

The software functional block 110 includes a query parser 111, a query planner 112, a query execution engine 113, a distributed file system 114, an accelerator storage plugin 115, an accelerator middleware 116, an accelerator driver 117, and an accelerator software model 118. The accelerator software model 118 is hereinafter referred to as software model 118. Note that, in the description below, the accelerator storage plugin may also be referred to as “plugin,” the accelerator middleware as “middleware,” and accelerator software model as “software model” for simplification.

Similarly, the functional configuration of the worker node 200 is categorized into a software functional block 210 and an accelerator 220. The software functional block 210 includes a query parser 211, a query planner 212, a query execution engine 213, a distributed file system 214, an accelerator storage plugin, or plugin, 215, an accelerator middleware, or middleware, 216, an accelerator driver 217, and an accelerator software model, or software model, 218.

Note that, since the worker nodes 100 and 200 have the same configuration, in the description below, the configuration of one of the worker nodes may be described while the description of the other worker node is omitted.

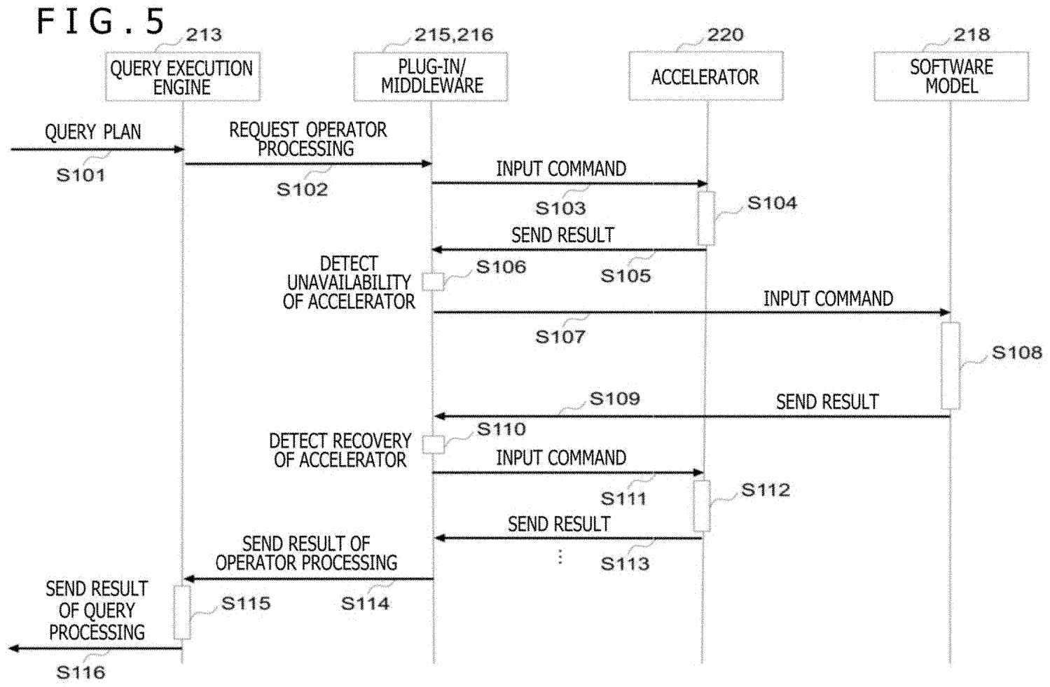

When an SQL query is sent from the application server 10, the worker nodes 100 and 200 executes the following process. Here, the outline of the process is described, and a detailed processing sequence will be described later below with reference to FIG. 5.

First, when an SQL query is sent from the application server 10 to the first worker node 20, 100 via the network 40, the query parser 111 analyzes the SQL query.

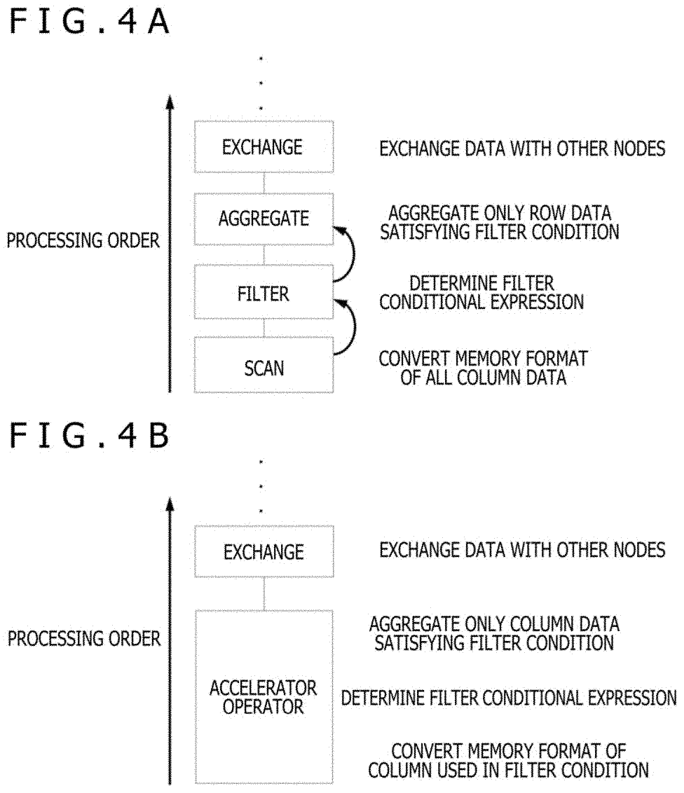

Then, the query planner 112 receives the analyzed result of the analysis and generates a query plan for the accelerator in cooperation with the plugin 115. Among query plans that include operations such as scan, filter, aggregate, exchange, and join, the query plan for an accelerator includes an “accelerator operator” that groups together operations processible by the accelerator 120, 220, e.g., scan, filter, and aggregate. Details will be described below with reference to FIGS. 4A and 4B. Then, the query plan generated by the query planner 112 is distributed to the other worker nodes 200. Note that the query plan may also be distributed to the worker node 100, as illustrated in FIG. 2. The subsequent processes executed by the worker node 100 in such a case are omitted.

In each of the worker nodes 200 that received the query plan, the query execution engine 213 analyzes the query plan and sends a processing command of the accelerator operator to the plugin 215. Then, the plugin 215 sends, to the middleware 216, a processing instruction, that is, accelerator operator, equivalent to the received accelerator operator. The middleware 216 receives the processing instruction, reads data from the distributed file system 214, and sends a processing instruction, that is, accelerator command, corresponding to the readout data to the accelerator 220 via the accelerator driver 217.

Here, if the accelerator 220 returns an error response, the middleware 216 switches the destination of the processing instruction to the software model 218, and continues the process. The software model 218 is software mimicking the function of the accelerator 220, and is executed by the CPU 21. Thus, the software model 218 receives a command equivalent to the accelerator command and returns a result equivalent to that from the accelerator 220.

Then, the middleware 216 executes collective processing of the results of multiple accelerator commands processed by the accelerator 220 or the software model 218, and returns the result to the plugin 215. The plugin 215 returns the result to the query execution engine 213. The query execution engine 213 executes the remaining processes under the instructions of an exchange operator and a join operator, and then sends the final result to the query execution engine 113 of the first worker node 20, 100.

Finally, the first worker node 20, 100 collects the processed results by the other worker nodes 20 including the worker node 200, in the cluster 30, and returns this as the final result of the SQL query to the application server 10 via the network 40.

Note that the query plan includes multiple operators and defines the processing order of the operators. The process of the accelerator operator is executed by collectively processing the processed results of multiple accelerator commands. An accelerator command is the minimum processing unit of the accelerator. For example, in the case where the accelerator query plan includes an accelerator operator, an exchange operator, and a join operator, in this processing order, the accelerator operator is broken down into multiple accelerator commands and processed. Then, the query execution engine 213 executes the exchange operator and the join operator in this order, see also FIGS. 4A and 4B.

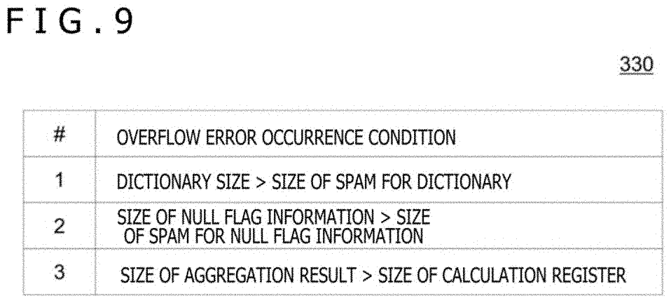

Since a dedicated circuit is used for the processing by the accelerator 220, the sizes of the memory and the register of the accelerator are limited compared with those of the CPU 21 and the memory 22 used in the software functional block 210. The target data to be processed by the accelerator commands, which are processing units of the accelerator 220, is provided without consideration of the limitations on the size of the accelerator memory. Thus, in some cases, overflow, or accelerator overflow error, may occur when the accelerator 220 reads the target data to be processed. Details of an accelerator overflow error will be described below with reference to FIG. 9.

When such overflow occurs in the embodiment, processing is switched from the accelerator 220 to the software model 218, as described above. The software model 218 has substantially no limiting conditions for the sizes of the memory and the register, unlike the accelerator 220. Thus, the software model 218 can process data and commands without resulting in an error even when the combination of the data and the commands may result in an error in processing by the accelerator 220, and can output a correct processed result. Thus, the worker node 200 according to the embodiment can continue processing, and achieve an advantageous effect in which the availability of the system is increased.

### (2) Switching Control Table

As described above, an example of a switching trigger from accelerator processing to software model processing includes the time of occurrence of an accelerator overflow error. However, the embodiment is not limited thereto. Examples of various switching conditions and recovery conditions will be described below.

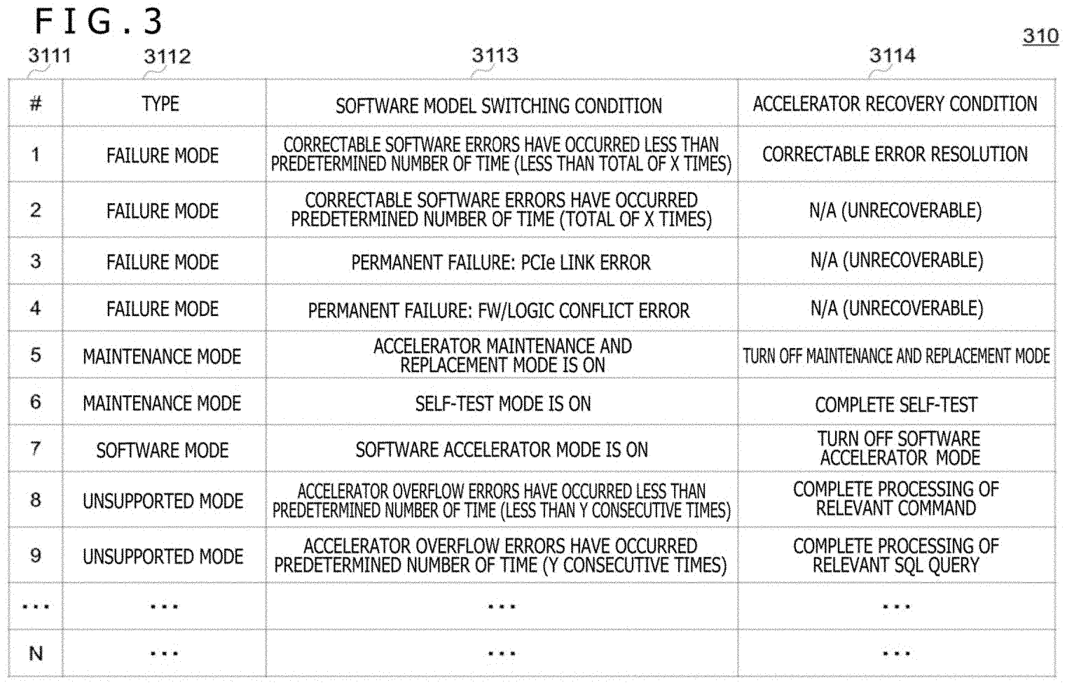

FIG. 3 illustrates an example of a switching control table. The switching control table is data for control having a table format, and the conditions of switching and recovery regarding the switching of the processing from the accelerator 220 to the software model 218 by the middleware 216 are established and registered in the switching control table.

A switching control table 310 illustrated in FIG. 3 includes serial number 3111, type 3112 indicating the mode type, software model switching condition 3113 indicating the condition for switching processing from the accelerator 220 to the software model 218, and an accelerator recovery condition 3114 indicating the condition for recovering to processing by the accelerator 220 after switching to processing by the software model 218.

The type 3112 is categorized into, for example, a failure mode, a maintenance mode, a software mode, and an unsupported mode. Detailed examples of control switching in each mode will be described below.

The failure mode is a mode type used during failure of the accelerator 220, or the entire accelerator 24. An example of failure of the accelerator 220 includes a software error caused by the influence of radiation, etc., that leads to a temporary correctable error. Such a correctable software error occurs is categorized as a “#1” or “#2” failure mode depending on whether the error has occurred a predetermined number of times, for example, X times. In detail, the total number of times the error has occurred may be recorded with a counter or the like, and the counter value may be compared with a predetermined threshold, “X” in this example.

As illustrated in FIG. 3, when a correctable software error occurs the number of times less than the predetermined number of times, the error is determined to be a temporary failure error. Thus, the middleware 216 switches to the software model 218 to continue the processing of the command that is to be executed by the accelerator 220, and recovers the processing by the accelerator 220 when the error is resolved (#1). The correctable software error is resolved, for example, by completing an error correction process. When the correctable software error occurs the number of time equal to the predetermined number of times, it is presumed that the error is highly likely to occur again even if the error is resolved. Thus, the error is determined to be a permanent failure error. At this time, the middleware 216 continues the processing of the command by switching to the software model 218, but the accelerator 220 is not recovered even after the error is resolved. Thus, the subsequent command processing is executed by the software model 218 (#2). Note that the recovery condition of “#2” may be, for example, a predetermined maintenance operation. In such a case, it is presumed that reoccurrence of the correctable software error can be avoided by performing a maintenance operation, such as replacement of the failed circuit.

Other examples of a failure of the accelerator 220 include non-availability of the accelerator 220 due to a PCIe link error, and an error due to a conflict in firmware or logic detected by the accelerator 220, that is, FW/logic conflict error. In such a case, it is presumed that processing by the accelerator 220 is difficult until a predetermined maintenance operation is performed. Thus, such failures are determined to be permanent errors (#3, #4). Thus, the middleware 216 continues to process the command by switching to the software model 218, and instructs the software model 218 to process the subsequent commands.

The maintenance mode is a mode type used during maintenance. In an example of the maintenance mode, when it is determined that the administrator turned on the maintenance and replacement mode when the accelerator 24 is to be maintained and replaced, the middleware 216 instructs the software model 218 to process all the remaining processing (#5). In such a case, the accelerator 220 is recovered under the conditions that the maintenance and replacement of the accelerator 24 be completed and the maintenance and replacement mode be turned off by the administrator.

Another example of the maintenance mode includes a self-test, or self-diagnosis. In a self-test, a specific test pattern is periodically executed to monitor the condition of the accelerator 220, 24. During the self-test, the usual SQL query processing cannot be executed by the accelerator 220. Thus, when it is determined that the self-test mode is turned on, the middleware 216 switches the processing to the software model 218, and when it is determined that the self-test has been completed, the middleware 216 recovers the processing by the accelerator 220 (#6).

The software mode is a mode type used when the worker node 200, 20 is provided with no accelerator 220, 24. In the software mode, acceleration processing is achieved by only the software model 218. In specific, when it is determined that a software accelerator mode is turned on, the middleware 216 switches to the processing by the software model 218, and when it is determined that the software accelerator mode is turned off, the middleware 216 recovers the processing by the accelerator 220 (#7).

The unsupported mode is a mode type used when the target data to be processed has a format that is not supported by the accelerator. An example of an unsupported mode includes the occurrence of the above-described accelerator overflow error. That is, when the data and commands cause overflow due to the limitations on the sizes of the memory and the register of the accelerator, the middleware 216 continues the processing of the command by switching to the software model 218 (#8, #9).

Note that, in the case illustrated in FIG. 3, the recovery conditions of an accelerator overflow error differ depending on whether the error has occurred a predetermined number of consecutive times, for example, Y times. An accelerator overflow error is not a failure of the accelerator 220, 24 but occurs depending on the combination of data and commands. Thus, when the error occurs a consecutive number of times less than the predetermined number of times, the accelerator 220 is recovered at the completion of command processing (#8). In contrast, when accelerator overflow occurs a predetermined consecutive number of times, it is presumed that the SQL query being processed continuously includes data and commands having properties that cause overflow of the accelerator 220. Thus, recovery in command processing units, as in #8, causes frequent repetition, and thereby the processing speed may decrease. Thus, in such a case, the current command as well as the subsequent commands is to be processed by the software model, and the accelerator 220 is recovered upon completion of the processing of the SQL query, more specifically, completion of the processing of the accelerator operator being executed and included in the query plan of the SQL query.

In the above-described embodiment, the switching between accelerator processing by the accelerator 220 and software model processing by the software model 218 can be appropriately controlled in accordance with the situation, such as failure, on the basis of the switching control table. This can achieve an advantageous effect in enhancing the availability of the system and maximizing the effect of acceleration, i.e., minimizing performance degradation due to switching to a software model.

Note that the processing speed of acceleration processing by the software model 218, or software model processing, is lower than an equivalent processing executed by the accelerator 220, or accelerator processing. However, the software model processing according to the embodiment can process an accelerator operator that groups the operations of scan, filter, and aggregate, and thereby reduce the processing load of the software model processing to increase the processing speed. This will be descried in detail below.

FIGS. 4A and 4B each illustrates software model processing of an accelerator query plan. FIG. 4A illustrates the processing outline of a query plan that has been used for past databases. FIG. 4B illustrates the outline of the software model processing of an accelerator query plan employable in the embodiment.

As illustrated in FIG. 4A, a past query plan includes operators, such as scan, filter, aggregate, and exchange, and the processing order of the operators is defined. First, during a scan operation, all data files, or column data, referred to in the SQL query statement are loaded to the memory, and data format conversion, or memory format conversion, is performed. Next, during a filter operation, the filter condition expression for the columns is determined for all items of column data that has been subjected to memory format conversion. Then, during an aggregation operation, only column data matching the filter condition is aggregated. Then, in an exchange operation, data is exchanged with other nodes. Such past query plan causes an increase in the load of the scan processing.

In contrast, as illustrated in FIG. 4B, an accelerator query plan of software model processing according to the embodiment includes an accelerator operator representing scan processing, filter processing, and aggregation processing. Here, column data that does not match the filter condition of the filter processing, among the data files referred to by the SQL query statement, is certainly not used in the subsequent aggregation processing. Thus, the column data requires no data format conversion, and the data format conversion can be skipped. In the software model processing, the internal processing order and processing content can be readily modified. The software model processing according to the embodiment first executes the scan processing of the accelerator operator to convert the data format, or memory format conversion, of only the column data, among the data files, to be used in the filter condition. Then, during filter processing, the data columns after memory format conversion are determined on the basis of filter condition expressions. During aggregation processing, only column data matching the filter condition is aggregated. Thus, in the software model processing according to the embodiment, only column data actually used in filtering and aggregation calculation should be subjected to memory format conversion that has a high load. Thus, the processing load of the accelerator operator can be reduced in comparison with that in past database processing, and an increase in the processing speed is expected. In particular, in the software model processing, as the proportion of columns not matching the filter condition increases, the load of the scan processing can be reduced. Thus, the effect of an increase in processing speed is higher than that of a method of database processing for software databases.

### (3) Query Processing

FIG. 5 is a sequence diagram illustrating the detailed steps of query processing. As described above, when an SQL query is sent from the application server 10, the query planner 112 of the worker node 100 generates a query plan for the accelerator and distributes the query plan to the worker node 200. FIG. 5 illustrates a detailed processing sequence of the query processing executed by a worker node 200 after the query plan is distributed.

First, the query planner 112 sends a query plan to the query execution engine 213, in step S101. When the query plan includes an accelerator operator, the query execution engine 213 sends an accelerator operator processing request to the plugin 215, in step S102. The plugin 215 sends an accelerator operator corresponding to the received accelerator operator processing request to the middleware 216.

Next, the middleware 216 breaks down the accelerator operator from the plugin 215 into multiple commands, and sequentially sends the commands to the accelerator 220, in step S103. The commands are broke down into data units.

The accelerator 220 executes command processing corresponding to the received commands, in step S104, and sends the processed result to the middleware 216, in step S105.

Here, presume that the middleware 216 detects temporary non-availability of the accelerator 220, in step S106. The middleware 216 may detect the non-availability, for example, through an interrupt notification, etc., from the accelerator 220 when the non-availability is caused by an internal failure of the accelerator 220 that can be detected by the accelerator 220 itself, or through confirmation of control information, such as the maintenance and replacement mode or the self-test mode.

When temporary non-availability of the accelerator 220 is detected in step S106, the middleware 216 determines whether the non-availability matches any of the software model switching conditions 3113 in the switching control table illustrated in FIG. 3. If the non-availability matches, the middleware 216 sends a command to the software model 218, in step S107. The software model 218 executes the processing of the command, in step S108, and returns the processed result to the middleware 216, in step S109. Note that, in general, the processing time of the software model processing in step S108 is longer than that of the accelerator processing in step S104.

Presume that the middleware 216 detects the recovery of the accelerator 220 after step S109, in step S110. The middleware 216 may detect the recovery, for example, through an interrupt notification, etc., from the accelerator 220 when the recovery that can be detected by the accelerator 220 itself, or through confirmation of control information, such as the maintenance and replacement mode or the self-test mode.

When recovery of the accelerator 220 is detected in step S110, the middleware 216 sends the subsequent command to the accelerator 220, in step S111. Then, similar to steps S104 and S105, the accelerator 220 executes command processing corresponding to the received commands, in step S112, and returns the processed result to the middleware 216, in step S113.

Subsequently, the middleware 216 sequentially sends commands to the accelerator 220 until all unprocessed commands regarding the accelerator operator received in step S102 are processed, and repeats steps S111 to S113, until it is detected that the situation no longer matches the software model switching condition 3113 in the switching control table. When the entire command processing regarding the accelerator operator is completed, the middleware 216 performs collective processing of the processed results of the commands and returns the result to the plugin 215. The plugin 215 returns the final processed result to the query execution engine 213, in step S114.

Then, the query execution engine 213 processes the remaining operators included in the query plan input in step S101, in step S115. When all operators are processed, the query execution engine 213 returns the result of the query processing to the worker node 100, in step S116. This completes the query processing in the worker node 200 in accordance with the query plan input in step S101.

Note that, for example, in step S105, when an overflow error, an FW/logic conflict error, or the like is reported to have occurred in the command processing by the accelerator 220, the corresponding command should be re-executed. In the embodiment, such errors are registered in the software model switching condition 3113 in the switching control table illustrated in FIG. 3. Thus, when an error or the like occurs, the middleware 216 switches to software model processing and instructs the re-execution of the command. In specific, the middleware 216 sends a command that is the same as the corresponding command to the software model 218, in step S107. The software model 218 processes the command, in step S108, and returns the processed result to the middleware 216, in step S109. In this way, the command that should be re-executed in the accelerator processing can be executed through the software model processing, and termination of the query processing due to an overflow error, an FW/logic conflict error, or the like can be avoided.

Next, the processing by the accelerator middleware, or middleware, 216 in the query processing by the worker node 200 will now be described in detail.

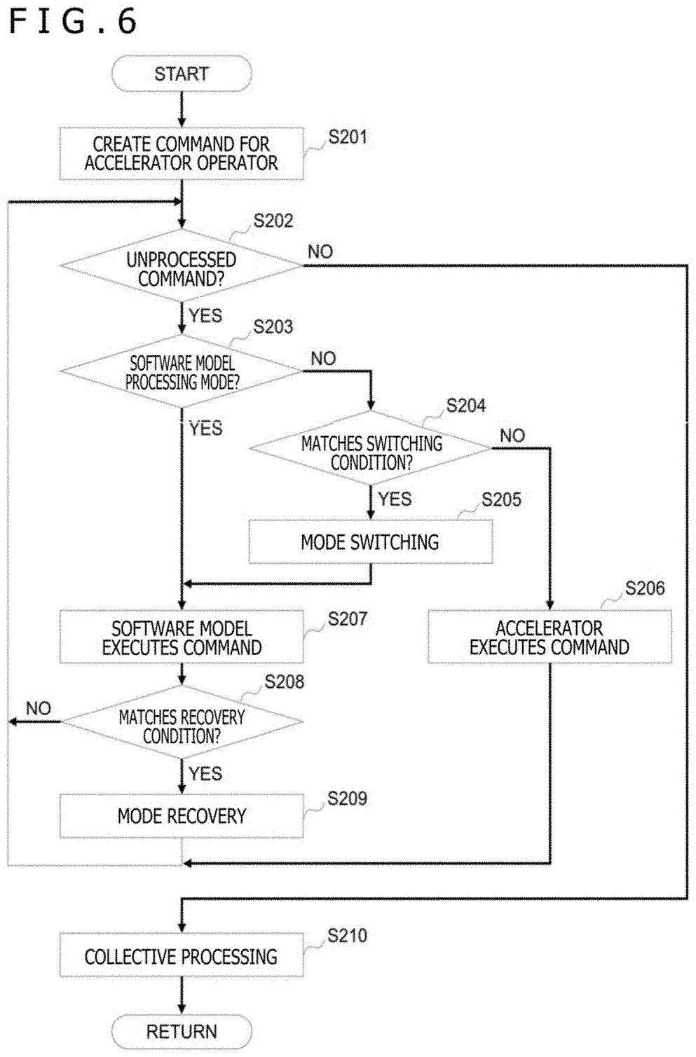

FIG. 6 is a flowchart illustrating a control process by the accelerator middleware. FIG. 6 illustrates a control flow by the middleware 216 from reception of an accelerator operator to collective processing after completion of processing of all commands regarding the accelerator operator, in steps S102 to S114 in FIG. 5.

When the middleware 216 receives an instruction for accelerator operator processing from the plugin 215, the middleware 216 performs command division to prepare multiple commands in divided data units, in step S201.

Then, the middleware 216 determines whether there are any unprocessed commands, in step S202. If there is an unprocessed command, that is, YES in step S202, step S203 is performed. If there is no unprocessed command, that is, NO in step S202, i.e., if all commands are processed, step S210 is performed.

In steps S203 to S209, the middleware 216 executes the control described below for each unprocessed command.

First, the middleware 216 determines whether the current processing mode is the software model processing mode, in step S203. As described above, in the information processing system, for example, worker node 200, according to the embodiment, the middleware 216 can switch the component to perform the command processing in accordance with a predetermined switching control table between the accelerator 220 and the middleware 216. In this description, the processing mode in which the accelerator 220 executes the command processing is referred to as accelerator processing mode, and the processing mode in which the middleware 216 executes the command processing is referred to as software model processing mode. If the processing mode is determined to be the software model processing mode in step S203, that is, YES in step S203, step S207 is performed. If the processing mode is determined not to be the software model processing mode in step S203, that is, NO in step S203, step S204 is performed.

In step S204, the middleware 216 determines whether to switch the processing mode to the software model processing mode on the basis of whether any of the software model switching conditions 3113 in the switching control table is satisfied. If any of the software model switching conditions 3113 is satisfied, that is, YES in step S204, the middleware 216 switches the processing mode from the accelerator processing mode to the software model processing mode, in step S205, and then performs step S207. In contrast, if none of the software model switching conditions 3113 is satisfied, that is, NO in step S204, the accelerator processing mode is maintained. Thus, the middleware 216 instructs the accelerator 220 to execute the unprocessed command, in step S206. Then, after the command execution is completed in step S206, step S202 is performed again to repeat the subsequent steps.

When step S207 is performed, the processing mode is the software model processing mode. The middleware 216 instructs the software model 218 to execute the unprocessed command, in step S207. After the command execution is completed in step S207, step S208 is performed.

In step S208, the middleware 216 determines whether to recover the accelerator processing mode on the basis of whether any of the software model switching conditions 3114 in the switching control table is satisfied. In specific, if the accelerator recovery condition 3114 in the same record as the software model switching condition 3113 determined to be satisfied in step S204 is satisfied, the accelerator recovery condition 3114 is determined to be satisfied, that is, YES in step S208. At this time, the middleware 216 executes the process for recovering the processing mode from the software model processing mode to the accelerator processing mode, in step S209, and performs step S202 to repeat the subsequent steps. In contrast, if the accelerator recovery condition 3114 is not satisfied, that is, NO in step S208, the middleware 216 does not recover of the processing mode, that is, performs step S202 to repeat the subsequent steps the processing mode while remaining in the software model processing mode.

When steps S203 to S209 are repeatedly performed for the unprocessed commands, and all commands are processed, the middleware 216 executes collective processing of the commands in step S210 and returns the result to the plugin 215. This completes the SQL query processing for the received accelerator operator.

As described above, the middleware 216 controls the processing mode on the basis of predetermined switching condition and recovery condition during the control of the command execution corresponding to the received accelerator operator, and thereby can appropriately use the software model 218.

### (4) Accelerator Overflow

In the description below, specific examples of the configuration of the accelerator, the configuration of the database files, and the occurrence condition of accelerator overflow are described as additional descriptions regarding the accelerator overflow exemplifying the switching condition to the software model processing.

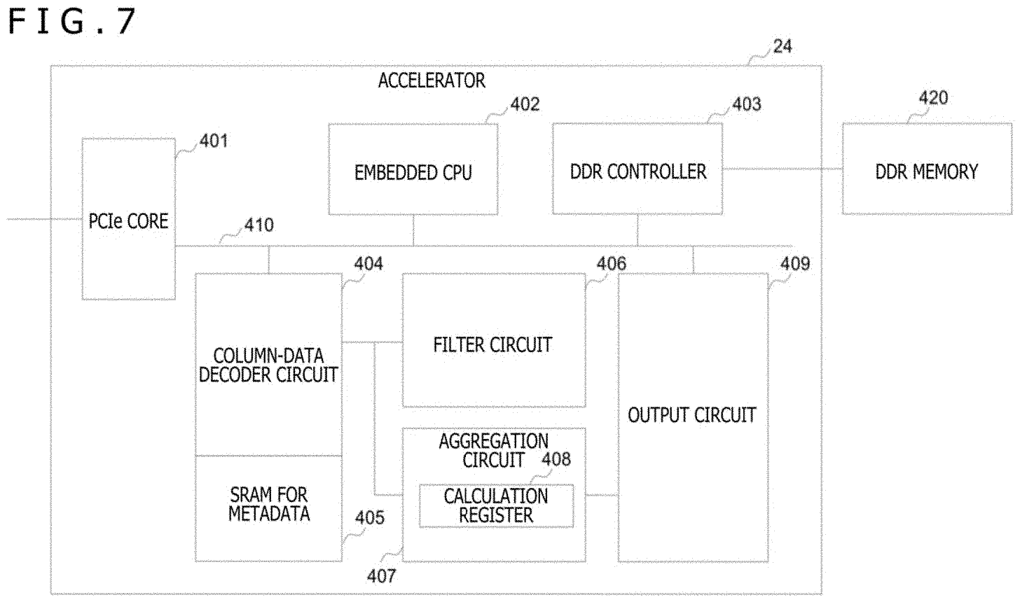

FIG. 7 is a block diagram illustrating a configuration example of the accelerator. FIG. 7 illustrates the configuration of an FPGA as an example of the accelerator 24. The DDR memory 420 illustrated in FIG. 7 is a specific example of the external memory 25 for the accelerator illustrated in FIG. 1.

As illustrated in FIG. 7, the accelerator 24 includes a PCIe core 401, an embedded CPU 402, a DDR controller 403, a column-data decoder circuit 404, a static random access memory (SRAM) 405 for metadata, a filter circuit 406, an aggregation circuit 407 including a calculation register 408, an output circuit 409, and an internal bus 410 that mutually connects the components.

The PCIe core 401 connects the inside and outside of the accelerator 24. The embedded CPU 402 operates firmware (FW) and performs comprehensive control of the command processing. The column-data decoder circuit 404 uses dictionary data stored in the SRAM 405 for metadata to decode, that is, performs dictionary extension, etc., of the column data. The metadata, such as dictionary data, is stored in the SRAM 405 for metadata inside the accelerator 24, not the DDR memory 420 outside the accelerator 24, to increase the decoding speed. The filter circuit 406 determines the column data matching the filter condition included in a command. The aggregation circuit 407 performs grouping and calculation of sums, or SUM values, of the columns. The calculated SUM values are stored in the calculation register 408 of the aggregation circuit 407. The output circuit 409 outputs the resulting data acquired through processing by the circuits to an external device of the accelerator 24.

In the accelerator 24 illustrated in FIG. 7, the resource size of the circuits has a upper limit, and the memory size of the recording devices such as the SRAM 405 for metadata and the calculation register 408, also have an upper limit. Thus, if a combination of data and commands exceeding such an upper limit is input to the accelerator 24 during acceleration processing, an overflow error occurs. The sizes of the resource and memory available in the CPU 21 and the memory 22 used in software model processing are significant large in comparison to those of the accelerator 24, and have substantially no limit. Thus, overflow errors hardly occur.

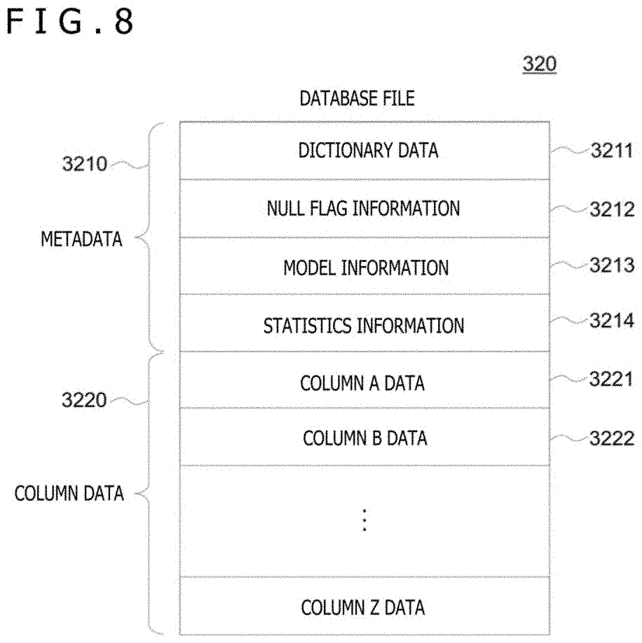

FIG. 8 illustrates a configuration example of a database file having a column store format. A database file 320 illustrated in FIG. 8 includes metadata 3210 and column data 3220.

The metadata 3210 includes dictionary data 3211, NULL flag information 3212 indicating whether each column value in the column data 3220 is NULL, model information 3213 of the columns, statistics information 3214, etc. Data of all columns is collectively stored in the column data 3220. In specific, in the case illustrated in FIG. 8, multiple consecutive column data items are stored, e.g., column A data 3221 is sequentially stored, and then column B data 3222 is sequentially stored.

The distributed database system includes database files 320 each having the configuration illustrated in FIG. 8. The distributed database system includes the database files 320 each divided into equal-sized data items and distributes these to the nodes. The middleware of each node correlates the commands and the database files in a one-to-one relation.

As described above, in a node, for example, worker node 200, according to the embodiment, the middleware 216 can execute command processing while switching between accelerator processing and software model processing in a small granularity of commands and corresponding database file units, i.e., by setting the processing unit per command to be one database file.

FIG. 9 illustrates specific examples of the occurrence condition of accelerator overflow. FIG. 9 illustrates specific conditions “#1” to “#3” under which an overflow error occurs in the accelerator 24 when the middleware 216 instructs command processing by accelerator processing, that is, when a command is input as in step S103 in FIG. 5.

The condition “#1” represents a case in which the data size of the dictionary data 3211 in the read database file 320 exceeds the upper limit of the memory size of the dictionary set in the SRAM 405 for metadata. The condition “#2” represents a case in which the data size of the NULL flag information 3212 in the read database file 320 exceeds the upper limit of the size of the memory for a NULL flag set in the SRAM 405 for metadata. The condition “#3” represents a case in which the aggregation result exceeds the memory size of the calculation register 408 during aggregation processing. When a situation matching any of the conditions “#1” to #3″ occurs, the accelerator processing is subjected to an overflow error, and the accelerator 24 cannot process the input command.

However, in the embodiment, the occurrence of accelerator overflow is registered to the switching control table as the software model switching condition 3113, as illustrated in FIG. 3. Thus, when accelerator overflow occurs, the middleware 216 can switch to software model processing and control the re-execution of the command. In software model processing, substantially no overflow errors occur. As a result, even when a command cannot be executed in accelerator processing, the command processing can be continued using software model processing.

(5) Comparison of the Embodiment with Background Art

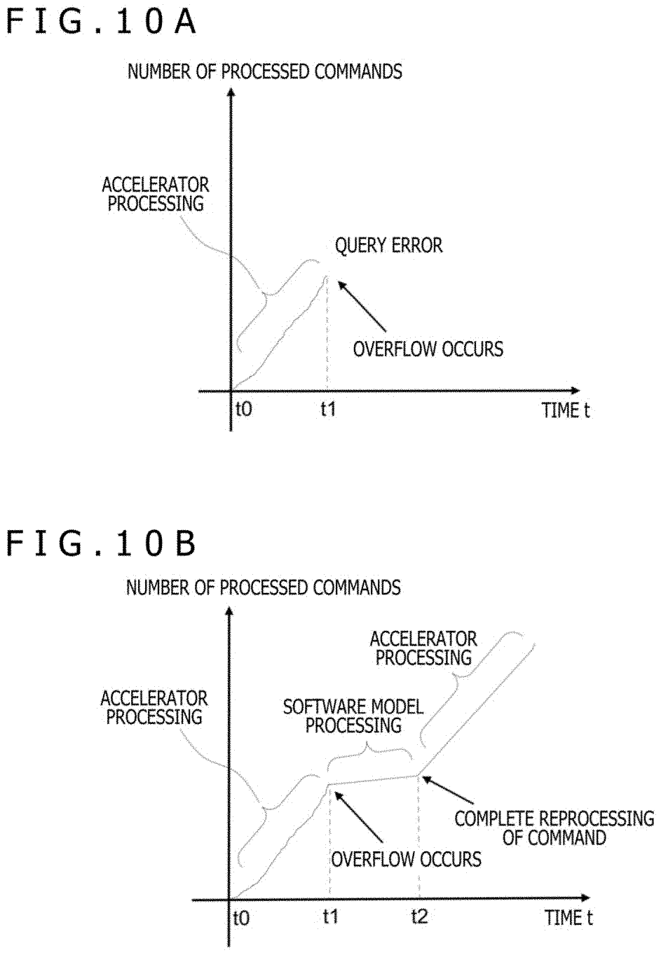

FIGS. 10A and 10B are diagrams for comparing the progress of SQL query processing according to the embodiment when an accelerator overflow error occurs, with past accelerator processing.

FIG. 10A illustrates an example of the progress of SQL query processing when an overflow error occurs during accelerator processing in a past database system. In detail, the accelerator processing starts at time t0, and the number of processed commands smoothly increase, but an overflow error occurs at time t1. In such a case, the SQL query processing is determined to have an error upon occurrence of the overflow error, and a query error is finally returned to the application server. Subsequently, the command processing is terminated.

In contrast, FIG. 10B illustrates an example of the progress of SQL query processing when an overflow error occurs during accelerator processing in the embodiment. In detail, the progress from time t0 at which the accelerator processing starts to time t1 at which an overflow error occurs is the same as that in FIG. 10A. Here, since the accelerator overflow error matches “#8” of the software model switching condition 3113 in the switching control table illustrated in FIG. 3, the middleware 216 switches to the software model processing at time t1. As a result, the command being processed at the time of the error can be re-processed through the software model processing between time t1 and time t2. Thus, the process can be continued while avoiding an SQL query error. Since the completion of the processing of the command at time t2 matches “#8” of the accelerator recovery condition 3114 in the switching control table, the middleware 216 recovers the accelerator processing. Thus, after time t2, the SQL query processing can be continued again through the accelerator processing.

Comparing FIGS. 10A and 10B, in the past database system, when the accelerator processing cannot continue due to an error, a failure, or the like, the SQL query processing enters a query error and the stops, whereas in the embodiment, the SQL query processing can be switched to the software model processing, thereby a query error can be avoided, and the availability of the system can be enhanced. As it is apparent from the progression illustrated in FIG. 10B, the processing speed of the software model processing is slower than that of the accelerator processing. However, the SQL query processing can be switched to the software model processing in units of accelerator commands, and thus, the period during which the processing is switched to the software model processing, which has a low processing speed, can be reduced as much as possible.

That is, in the embodiment, processing performance is enhanced through the introduction of accelerators to the nodes of the distributed database system, as well as enabling switching to and recovering from accelerator processing and software model processing in units of accelerator commands. Thus, flexibility can be enhanced during introduction of the accelerators and troubleshooting can be achieved, and thereby the availability of the system can be increased.

Note that the present invention is not limited to the above-described embodiment, and various modifications are included. For example, the embodiment described above has been described in detail to clearly explain the present invention, and do not necessarily include every component described above. A portion of the configuration according to the embodiment may include an additional component, or may have components removed or replaced by another component. For example, the present invention may be widely applied to information processors and information processing systems that execute processing instructed by a client on the basis of information acquired from a distributed database system and have various configurations.

In the drawings, the control lines and the information lines indicate what are considered necessary for explanation, and do not represent all control lines and information lines of the product. Substantially all configurations may be considered interconnected for implementation.

What is claimed is:

1. An information processor that executes query processing in accordance with a distributed query plan, the information processor comprising:
a processor;
an accelerator that executes, with a dedicated circuit, accelerator processing for processing a command; and
a software model that operates on the processor and executes software model processing, with software, to process the command,
the processor breaking down an accelerator operator included in the query plan into a plurality of accelerator commands and sending each of the accelerator commands to the accelerator or the software model,
the processor switching a destination of the accelerator commands from the accelerator to the software model when a switching condition for changing a processing component of the accelerator commands is satisfied.

2. The information processor according to claim 1, wherein,
the switching condition includes a recovery condition for recovering the switched destination of the accelerator commands, and
the destination of the accelerator commands is switched from the software model to the accelerator when the recovery condition is satisfied.

3. The information processor according to claim 1, wherein
the processor switches the destination of the accelerator commands in a processing unit corresponding to processing of each of the accelerator commands.

4. The information processor according to claim 2, wherein,
memories to be used by the processor and the accelerator are predetermined, and
the switching condition includes occurrence of an overflow error of the accelerator.

5. The information processor according to claim 4, wherein,
when the switching condition is the occurrence of an overflow error of the accelerator,
the recovery condition is completion of processing of one of the accelerator commands by the software model after the destination is switched on a basis of the switching condition when the overflow error has not occurred a consecutive number of times equal to a first threshold, and
the recovery condition is completion of processing of the accelerator operator by the software model after the destination is switched on a basis of the switching condition when the overflow error has occurred a consecutive number of times equal to the first threshold.

6. The information processor according to claim 2, wherein the switching condition includes occurrence of a correctable software error of the accelerator.

7. The information processor according to claim 6, wherein,
when the switching condition is the occurrence of the correctable software error of the accelerator,
the recovery condition is resolution of the correctable software error after the destination is switched to the software model on a basis of the switching condition when the correctable software error has not occurred a total number of times equal to a second threshold,
a recovery to the accelerator is not permitted after the destination is switched to the software model on a basis of the switching condition when the correctable software error has occurred a consecutive number of times equal to the second threshold.

8. The information processor according to claim 1, wherein,
when the accelerator operator is processed through software model processing, the software model performs memory format conversion on only column data used for a filter condition, among data files referred to by a query statement, performs filter determination using the filter condition on the column data on which memory format conversion has been performed, and aggregates only the column data matching the filter condition.

9. The information processor according to claim 1, wherein
the accelerator comprises a field programmable gate array.

10. An information processing system processing a query with a cluster grouping a plurality of worker nodes, the information processing system comprising:
an application server that transmits the query to a first worker node in the cluster;
the first worker node that receives the query from the application server, and distributes a query plan generated on a basis of the query to a second worker node in the cluster; and
the second worker node that executes query processing in accordance with the query plan distributed by the first worker node, wherein,
the second worker node includes
a processor,
an accelerator that executes, with a dedicated circuit, accelerator processing for processing a command, and
a software model that operates on the processor and executes software model processing, with software, to process the command,
the processor breaks down an accelerator operator included in the query plan into a plurality of accelerator commands and sending each of the accelerator commands to the accelerator or the software model, and
the processor switches the destination of the accelerator commands from the accelerator to the software model when a switching condition for changing a processing component of the accelerator commands is satisfied.

11. The information processing system according to claim 10, wherein,
the switching condition includes a recovery condition for recovering the switched destination of the accelerator commands, and
the destination of the accelerator commands is switched from the software model to the accelerator when the recovery condition is satisfied.

12. A method of processing information for an information processor that executes query processing in accordance with a distributed query plan and that includes a processor, an accelerator that executes, with a dedicated circuit, accelerator processing for processing a command, and a software model that operates on the processor and executes software model processing, with software, to process the command, the method comprising:
by the processor, breaking down an accelerator operator included in the query plan into a plurality of accelerator commands and sending each of the accelerator commands to the accelerator or the software model, and
by the processor, switching a destination of the accelerator commands from the accelerator to the software model when a switching condition for changing a processing component of the accelerator commands is satisfied.

13. The method of processing information according to claim 12, wherein,
the switching condition includes a recovery condition for recovering the switched destination of the accelerator commands, and
the destination of the accelerator commands is switched from the software model to the accelerator when the recovery condition is satisfied.

14. The method of processing information according to claim 12, wherein
the processor switches the destination of the accelerator commands in a processing unit corresponding to processing of each of the accelerator commands.

15. The method of processing information according to claim 12, wherein
when the accelerator operator is processed through software model processing, the software model performs memory format conversion on only column data used for a filter condition, among data files referred to by a query statement, performs filter determination using the filter condition on the column data on which memory format conversion has been performed, and aggregates only the column data matching the filter condition.
